(19) United States
(12) Patent Application Publication
(10) Pub. No.: US 2011/0182251 A1
(43) Pub. Date: Jul. 28, 2011

(54) CLOSED LOOP ADAPTATION OF DEVICE SCHEDULING PARAMETERS

(75) Inventors: Ritesh Kumar Madan, Jersey City, NJ (US); Ashwin Sampath, Skillman, NJ (US)

(73) Assignee: QUALCOMM Incorporated, San Diego, CA (US)

(21) Appl. No.: 12/844,636

(22) Filed: Jul. 27, 2010

Related U.S. Application Data
(60) Provisional application No. 61/229,189, filed on Jul. 28, 2009.

(51) Int. Cl. H04W 72/04

(52) U.S. Cl. 370/329

(57) ABSTRACT

Systems and methodologies are described that facilitate adapting wireless device scheduling parameters at least in part by adjusting prioritized bit rates (PBR) of one or more logical channels. The PBRs can be adjusted according to feedback from a media access control layer scheduler or a radio link control layer regarding resource allocations to one or more wireless device, served rate for one or more wireless device, and/or the like. Adjusting the PBRs based on the feedback can increase likelihood that data can be transmitted over substantially all or a specified set of logical channels. Moreover, PBRs can be modified for specific wireless devices based further on resource allocations thereto. Furthermore, PBRs can be modified based at least in part on radio conditions of neighboring access points.

### CROSS-REFERENCE

This application claims the benefit of U.S. Provisional Application Ser. No. 61/229,189, filed Jul. 28, 2009, and entitled “CLOSED LOOP ADAPTATION OF USER EQUIPMENT SCHEDULING PARAMETERS ON UPLINK,” the entirety of which is incorporated herein by reference.

### BACKGROUND

I. Field

The present disclosure relates generally to wireless communications and more specifically to scheduling communication resources to user equipment in a wireless network.

II. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), etc.

Generally, wireless multiple-access communication systems may simultaneously support communication for multiple mobile devices. Each mobile device may communicate with one or more access points (e.g., base stations, femtocells, picocells, relay nodes, and/or the like) via transmissions on forward and reverse links. The forward link (or downlink) refers to the communication link from access points to mobile devices, and the reverse link (or uplink) refers to the communication link from mobile devices to access points. Further, communications between mobile devices and access points may be established via single-input single-output (SISO) systems, multiple-input single-output (MISO) systems, multiple-input multiple-output (MIMO) systems, and so forth. In addition, mobile devices can communicate with other mobile devices (and/or access points with other access points) in peer-to-peer wireless network configurations.

In addition, access points and mobile devices can communicate over one or more logical channels, such as one or more data channels (e.g., for voice, data, streaming, etc.), control channels, access channels, etc., which can relate to a given mobile device or be shared among multiple mobile devices. Moreover, each logical channel (or a grouping of logical channels) can be assigned a priority and prioritized bit rate (PBR) for the logical channel (or grouping). The priority and PBR can be signaled to a mobile device for allocating resources assigned by the access point to one or more of the logical channels to meet data requirements for the one or more logical channels. On the uplink, the mobile device or UE (user equipment) conforms to rules regarding the order and amount of data to multiplex per logical channel (or grouping) in the assigned resources from the base station.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

In accordance with one or more embodiments and corresponding disclosure thereof, various aspects are described in connection with facilitating adaptively adjusting prioritized bit rate (PBR) for logical channels or related logical channel groups based at least in part on feedback from a resource scheduler (e.g., at a media access control (MAC) layer), a radio link control (RLC) layer, and/or the like. For example, the feedback can include resource allocation parameters related to one or more wireless devices, average serving rate for the one or more wireless devices, and/or similar parameters. The adjusted PBR can be communicated by the scheduler to a radio resource control (RRC) layer in the access point and then communicated to a wireless device through RRC signaling. The adjusted PBR can be provided to a scheduler, which can be at an access point, to modify a scheduling policy for one or more wireless devices. The wireless device can then allocate resources from the assigned resources in accordance with the adjusted PBR. In one example, PBR for a logical channel or group can be adjusted as a function of resource allocation to a given wireless device or substantially all wireless devices. It is to be appreciated, for example, that such PBR adjustment can increase likelihood that at least a portion of resources at a given wireless device are allocated to each logical channel or group for communicating with the access point.

According to an aspect, a method is provided that includes assigning a priority and a PBR to one or more logical channels and receiving one or more feedback parameters regarding communicating over at least a portion of the one or more logical channels. The method further includes generating an adjusted PBR from the PBR according to the one or more feedback parameters.

Another aspect relates to a wireless communications apparatus. The wireless communications apparatus can include at least one processor configured to define a priority and a PBR for one or more logical channels and obtain one or more feedback parameters related to communicating with one or more wireless devices over at least a subset of the one or more logical channels. The at least one processor is further configured to modify the PBR to an adjusted PBR according to the one or more feedback parameters. The wireless communications apparatus also comprises a memory coupled to the at least one processor.

Yet another aspect relates to an apparatus. The apparatus includes means for assigning a priority and a PBR to one or more logical channels and means for receiving one or more feedback parameters regarding communicating over at least a subset of the one or more logical channels. The apparatus also includes means for modifying the PBR to an adjusted PBR according to the one or more feedback parameters.

Still another aspect relates to a computer program product, which can have a computer-readable medium including code for causing at least one computer to define a priority and a PBR for one or more logical channels and code for causing the at least one computer to obtain one or more feedback parameters related to communicating with one or more wireless devices over at least a subset of the one or more logical channels. The computer-readable medium can also comprise code for causing the at least one computer to modify the PBR to an adjusted PBR according to the one or more feedback parameters.

Moreover, an additional aspect relates to an apparatus including a channel initializing component that assigns a priority and a PBR to one or more logical channels and a feedback receiving component that obtains one or more feedback parameters regarding communicating over at least a subset of the one or more logical channels. The apparatus can further include a PBR adjusting component that modifies the PBR to an adjusted PBR according to the one or more feedback parameters.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed, and the described embodiments are intended to include all such aspects and their equivalents.

### BRIEF DESCRIPTION OF THE DRAWINGS

FIG. 1 is an illustration of an example system for providing feedback among multiple layers to modify one or more prioritized bit rates (PBR).

FIG. 2 is a block diagram of an example wireless communications system for adjusting PBRs based on feedback regarding device communications.

FIG. 3 illustrates an example wireless communication system for optimizing PBRs according to a utility function.

FIG. 4 illustrates an example wireless communication system for adjusting PBRs based on parameters of neighboring access points.

FIG. 5 is a flow diagram of an example methodology that adjust PBRs based at least in part on feedback from a scheduler or radio link control (RLC) layer.

FIG. 6 is a flow diagram of an example methodology that modifies PBRs for a specific wireless device.

FIG. 7 is a flow diagram of an example methodology that facilitates optimizing one or more PBRs based on a utility function.

FIG. 8 is a flow diagram of an example methodology that modifies a scheduling policy based on an adjusted PBR.

FIG. 9 is a block diagram of an example apparatus that adjusts PBRs based on feedback from a scheduler or RLC layer.

FIGS. 10-11 are block diagrams of example wireless communication devices that can be utilized to implement various aspects of the functionality described herein.

FIG. 12 illustrates an example wireless multiple-access communication system in accordance with various aspects set forth herein.

FIG. 13 is a block diagram illustrating an example wireless communication system in which various aspects described herein can function.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point or Evolved Node B (eNB) or other Node B) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various techniques described herein can be used for various wireless communication systems, such as Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier FDMA (SC-FDMA) systems, and other such systems. The terms “system” and “network” are often used herein interchangeably. A CDMA system can implement a radio technology such as Universal Terrestrial Radio Access (UTRA), CDMA2000, etc. UTRA includes Wideband-CDMA (W-CDMA) and other variants of CDMA. Additionally, CDMA2000 covers the IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Further, CDMA2000 and UMB are described in documents from an organization named “3rd Generation Partnership Project 2” (3GPP2).

Various aspects will be presented in terms of systems that can include a number of devices, components, modules, and the like. It is to be understood and appreciated that the various systems can include additional devices, components, modules, etc. and/or can not include all of the devices, components, modules etc. discussed in connection with the figures. A combination of these approaches can also be used.

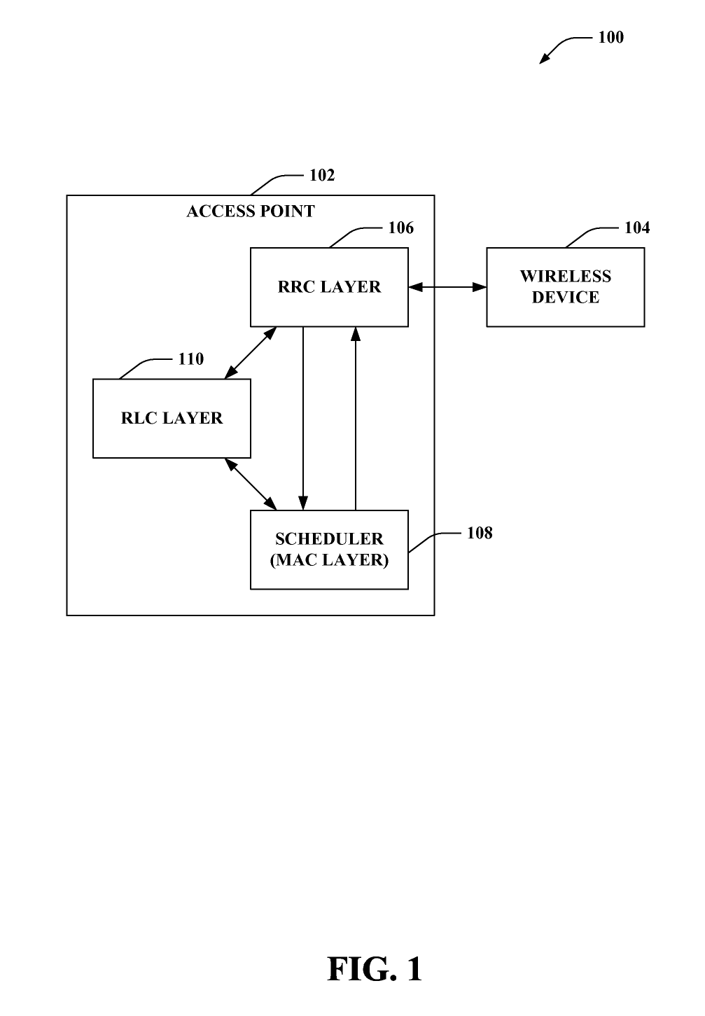

Referring now to the drawings, FIG. 1 illustrates an example system 100 that facilitates determining prioritized bit rates (PBR) for one or more logical channels. System 100 includes an access point 102 that can provide wireless device 104 (or one or more disparate wireless devices) with access to a wireless network or other device (not shown). For example, access point 102 can allocate a plurality of resources and related logical channels to wireless device 104 for communicating with the wireless network or other device. The logical channels can relate to communicating different types of data (e.g., voice data, control data, web data, streaming data, etc.) over communications resources and can have associated bit rate and/or quality of service (QoS) requirements. The communications resources can relate to portions of frequency over portions of time, in one example, such as one or more orthogonal frequency division multiplexing (OFDM) symbols, one or more frequency sub-carriers, and/or the like. For example, the logical channels can include physical uplink shared channel (PUSCH), physical uplink control channel (PUCCH), physical downlink shared channel (PDSCH), physical downlink control channel (PDCCH), and/or other shared or dedicated channels in an LTE wireless network. It is to be appreciated that access point 102 can be substantially any device that provides access to one or more network components, such as a macrocell access point, femtocell or picocell access point, eNB, mobile base station, relay node, a portion thereof, and/or the like. In addition, wireless device 104 can be substantially any device that receives access to a wireless network, such as a mobile device, UE, relay node, modem (or other tethered device), a portion thereof, etc.

Access point 102 can comprise one or more layers (or related components) for communicating with wireless device 104 or other wireless devices. For example, access point 102 can include a radio resource control (RRC) layer 106 that communicates with wireless device 104 over a radio interface and a scheduler 108, which is part of a media access control (MAC) layer, that determines resources over which to transmit and/or receive data in one or more logical channels and/or one or more devices. The RRC layer, for example, can include a radio resource management (RRM) layer or component (not shown) that can adjust radio parameters at the RRC layer based on priority and/or PBR of a corresponding logical channel. Access point 102 also comprises a radio link control (RLC) layer 110 that provides data to and/or receives data from the MAC layer for communicating with wireless device 104 over the one or more logical channels.

According to an example, upon establishing a connection with wireless device 104, scheduler 108 allocates resources to the wireless device 104 for communicating with access point 102. In addition, as described, one or more logical channels can be established, and wireless device 104 can communicate data related to the logical channels over the allocated resources. In one example, RRC layer 106 can signal a priority and PBR for each of the one or more logical channels or groupings thereof to wireless device 104. Thus, for example, wireless device 104 can utilize the priority and PBR to assign the allocated resources to the one or more logical channels or groupings. In one example, wireless device 104 can provide resources to a highest priority logical channel or grouping to achieve the corresponding PBR, then provide resources to a next highest priority logical channel or grouping to achieve its PBR, etc.

In an example, RRC layer 106 (and/or a disparate layer or component of access point 102) can adjust PBR for the one or more logical channels (e.g., through an RRM layer or component, etc.) based at least in part on feedback from the scheduler 108 or RLC layer 110. For example, the scheduler 108 and/or RLC layer 110 can report feedback to the RRC layer 106 (or other layer or component) related to resource allocation to each wireless device (e.g., a number of resource blocks, transport format, etc.), which can be averaged over time as a resource allocation history, an average rate at which each wireless device is served by access point 102, an average rate at which each logical channel of each wireless device is served, statistics of inter-services times, average carrier-to-interference (C/I) ratio at which signals are received at the wireless devices, a combination thereof, PBRs for other logical channels or groupings, and/or the like. It is to be appreciated that some of the foregoing values are computed by scheduler 108 or RLC layer 110, received from wireless device 104 and/or other wireless devices over control resources, and/or the like. RRC layer 106 can provide the adjusted PBRs to scheduler 108, which can modify a scheduling policy related to one or more wireless devices based at least in part on the adjusted PBRs. For example, this can include modifying the scheduling policy to allocate additional resources to a logical channel where a PBR is increased, reduce resources where a PBR is decreased, etc.

In an example, RRC layer 106 (or other layer or component) can tailor PBR for one or more logical channels based on feedback regarding a size of resources allocated on average to one or more wireless devices. In this example, in the average case, substantially all logical channels can transmit over allocated resources. RRC layer 106, for example, can additionally provide the adjusted PBRs to wireless device 104, which can modify logical channel transmission rates according to the adjusted PBRs. It is to be appreciated that the RRC layer 106 can send the PBRs to wireless device 104 (or a portion thereof) once the PBR reaches a threshold level, varies from a previous PBR over a threshold variance, and/or the like. Moreover, for example, RRC layer 106 (or other layer or component) can adjust the PBRs for a plurality of logical channels related to wireless device 104 by determining PBRs that maximize the sum of the utilities of average rates of all logical channels across all wireless devices served by access point 102, where the utility can be a concave increasing function of the average rate.

In another example, upon receiving the adjusted PBRs, scheduler 108 can utilize the PBRs to modify scheduling policy as the PBRs evolve over time. It is to be appreciated that a subset or portion of the logical channels or groupings can have a guaranteed bit rate (GBR) for communicating thereover. In this example, RRC layer 106 can provide PBRs that are at least at the GBR. For logical channels or groupings that are best-efforts (e.g., web data, some streaming, etc.), for example, RRC layer 106 can vary the PBRs according to remaining resources. In addition, RRC layer 106 can adjust the PBRs according to priority of a given logical channel or grouping, as described. In yet another example, the scheduler 108 can compute and adjust PBRs and provide to the RRC layer 106 for communicating to wireless device 104.

Thus, for example, for downlink scheduling, RRC layer 106 can adjust resources for related logical channels according to the feedback from scheduler 108 and/or RLC layer 110. For uplink scheduling, RRC layer 106 signals the determined PBRs to wireless device 104. Wireless device 104 can thus multiplex bits over assigned resources related to given logical channels based at least in part on the adjusted PBRs received from the RRC layer 106 signals. Such adjusting and signaling of PBRs, as described herein, allows for gradually correcting PBR at a wireless device 104, for example.

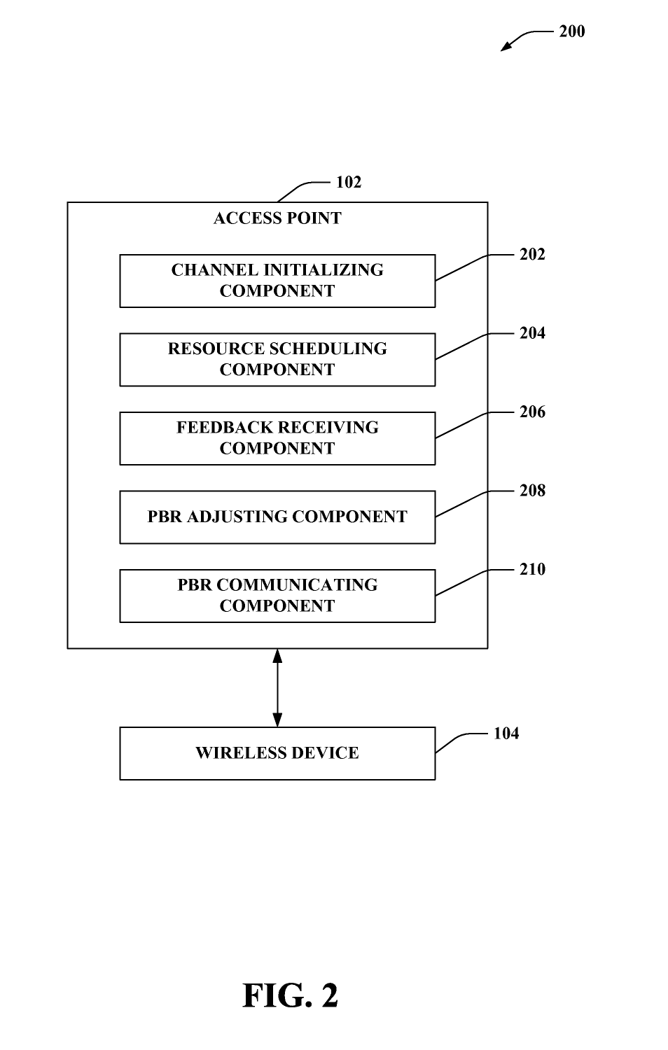

Referring next to FIG. 2, illustrated is a wireless communications system 200 that facilitates adapting PBR for one or more logical channels based at least in part on one or more scheduling parameters. System 200 includes an access point 102 that provides one or more wireless devices, such as wireless device 104, with access to a wireless network (not shown). As described, access point 102 can communicate with wireless device 104 over one or more logical channels. Access point 102 can be a macrocell access point, femtocell access point, picocell access point, relay node, mobile base station, a portion thereof, and/or substantially any device that provides wireless network access. In addition, for example, wireless device 104 can be a UE, modem (or other tethered device), a portion thereof, and/or substantially any device that receives access to a wireless network, as described.

Access point 102 can comprise a channel initializing component 202 that implements one or more logical channels for communicating with wireless device 104 over a set of allocated resources and a resource scheduling component 204 that assigns resources to wireless device 104 for communicating over the one or more logical channels. Access point 102 additionally comprises a feedback receiving component 206 that obtains feedback related to communicating with wireless device 104 and/or other wireless devices, a PBR adjusting component 208 that can modify a PBR related to the one or more logical channels based on the feedback, and a PBR communicating component 210 that provides the modified PBR to the wireless device 104.

According to an example, wireless device 104 can establish a connection with access point 102 (e.g. by performing a random access procedure therewith in LTE), and channel initializing component 202 can create one or more logical channels for communicating with wireless device 104. In addition, channel initializing component 202 can define a priority and PBR for the one or more logical channels. In another example, channel initializing component 202 can group the logical channels and assign a priority and PBR per group. Though described in terms of logical channels below, the functionality as described herein can also be applied to groups of logical channels. In one example, channel initializing component 202 can set the PBR according to a set of resources allocated to wireless device 104 by access point 102. In addition, for example, channel initializing component 202 can set the PBR for one or more logical channels according to a GBR related to the one or more logical channels (e.g., such that the PBR is no less than the GBR).

In this example, resource scheduling component 204 can allocate a set of resources to wireless device 104 for communicating with access point 102 over the logical channels, which can relate to a type of data transmission (voice, web, streaming, etc.), as described. Wireless device 104, for example, can utilize a portion of the set of resources to communicate over each logical channel based at least in part on the priority and PBR. Thus, for example, wireless device 104 can assign a portion of the set of resources to a highest priority logical channel necessary to achieve the PBR, then assign a portion of the remaining resources to a next highest priority logical channel, and so on. In this regard, channel initializing component 202 communicates the priority and PBR to wireless device 104 (e.g., via RRC signaling) and can set the PBR according to various criteria, such as a number or size of resources initially allocated to wireless device 104, feedback from resource scheduling component 204 (e.g., which can operate in a MAC layer and can determine statistics regarding resources assigned to one or more wireless devices) or RLC layer regarding communications with other wireless devices, and/or the like.

Once connected to wireless device 104, access point 102 can adjust PBR for one or more of the logical channels based on feedback regarding communications therewith and/or with other wireless devices. For example, feedback receiving component 206 can obtain one or more feedback parameters from resource scheduling component 204, an RLC layer, and/or the like regarding communications with wireless device 104 and/or one or more disparate wireless devices. PBR adjusting component 208 can modify a PBR for one or more of the logical channels based at least in part on the one or more feedback parameters. In one example, PBR adjusting component 208 can determine average resources expected to be allocated to wireless device 104 over time based on the one or more feedback parameters and can adjust the PBR accordingly.

For example, feedback receiving component 206 can obtain feedback parameters from resource scheduling component 204 and/or RLC layer, such as a resource allocation to each wireless device (e.g., resource allocation history averaged over time), average rate at which each wireless device is served, and/or the like, as described above. PBR adjusting component 208 can modify PBR of one or more logical channels according to the one or more parameters. In one example, where a resource allocation history to each wireless device averaged over time is received by feedback receiving component 206, PBR adjusting component 208 can adjust PBR of one or more logical channel as a function of the resource allocation history average to increase a likelihood that the one or more logical channels are transmitted between access point 102 and the wireless devices (e.g., including wireless device 104). For instance, where the resource allocation history is below a threshold level (or lower than a previous level), PBR adjusting component 208 can modify a PBR to a lesser value to allow other logical channels to transmit using the resource allocation history.

In one example, as described, PBR adjusting component 208 can modify PBRs for the one or more logical channels by ensuring PBR of logical channels with a GBR is at least the GBR, and then can optimize PBRs among the remaining logical channels by increasing PBR based on remaining available resources (and/or the logical channels with GBR by increasing the PBR beyond the GBR based on remaining resources). In another example, PBR adjusting component 208 can modify PBR of one or more logical channels to ensure that substantially all logical channels (or at least a specified set of logical channels) have a high likelihood of receiving resources at a wireless device based on an assigned PBR and PBRs assigned to other logical channels. In yet another example, resource scheduling component 204 computes desired rates to maximize the sum utility of average rates of all logical channel for substantially all wireless devices served by access point 102; PBR adjusting component 208 can then modify the PBR of one or more logical channels based on these computed rates. In any case, PBR adjusting component 208 can provide adjusted PBRs to resource scheduling component 204, which can define or modify a resource scheduling policy for wireless devices according to the adjusted PBRs and/or a determined trend of the PBRs over time. In addition, an RRC layer of access point 102 can utilize the adjusted PBRs in communicating with wireless device 104 and/or other wireless devices over the corresponding logical channels. Furthermore, PBR communicating component 210 can communicate changes to PBR to wireless device 104 (e.g., via RRC signaling), and wireless device 104 can multiplex logical channels when communicating with access point 102 according to the changes. Moreover, for example, PBR communicating component 210 can provide the changes to wireless device 104 only where the changes are above a threshold level as compared to one or more previous PBR values.

In another example, feedback receiving component 206 can receive one or more feedback parameters related to wireless device 104 and/or a given logical channel related to wireless device 104, along with parameters related to substantially all wireless devices served by access point 102. For example, feedback receiving component 206 can obtain a current or average resource allocation or resource allocation history related to substantially all wireless devices for a given logical channel, and PBR adjusting component 208 can further modify a PBR specifically for the given logical channel of wireless device 104 according to the resource allocation or history to wireless device 104. In this example, PBR communicating component 210 can provide the specific PBR to wireless device 104.

It is to be appreciated, in one example, that such PBR adjustment can impact best efforts traffic (e.g., web data, such as hypertext transfer protocol (HTTP), file transfer protocol (FTP), and/or the like) between access point 102 and wireless device 104. In one example, where average resource allocation (or other feedback parameters) indicate favorable conditions at wireless devices served by access point 102 (e.g., large resource allocation, high served rate, high C/I ratio, etc.), best efforts traffic can be assigned a higher PBR than where conditions are unfavorable (e.g., comparably small resource allocation, low served rate, low C/I ratio, etc.).

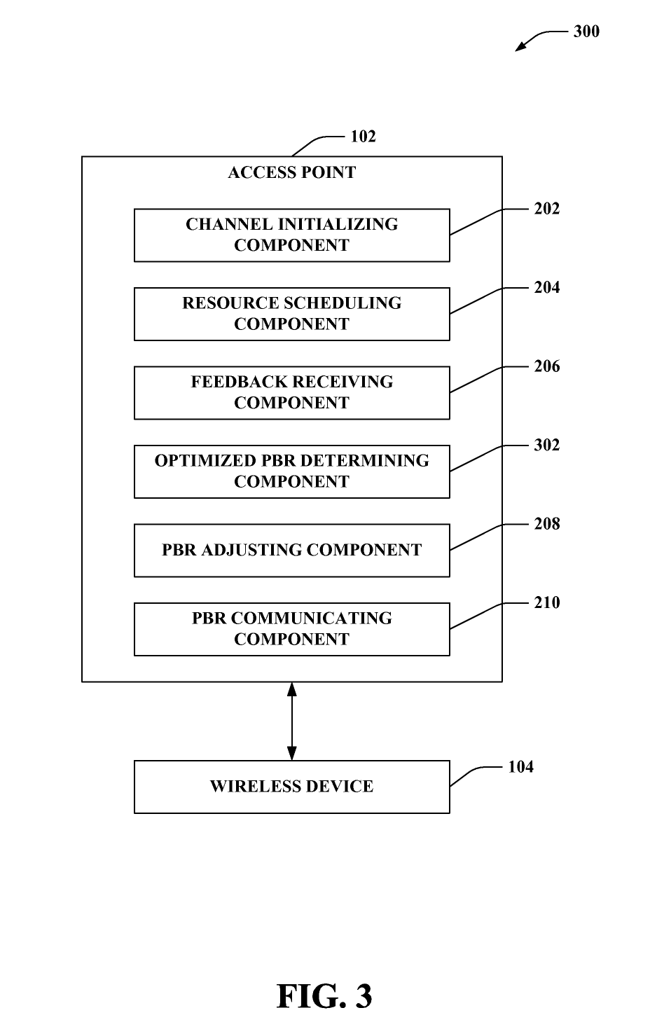

Turning to FIG. 3, illustrated is a wireless communications system 300 that facilitates adjusting PBRs for one or more logical channels to maximize utility of the one or more logical channels over one or more wireless devices. System 300 includes an access point 102 that provides one or more wireless devices, such as wireless device 104, with access to a wireless network (not shown). As described, access point 102 can communicate with wireless device 104 over one or more logical channels. Access point 102 can be a macrocell access point, femtocell access point, picocell access point, mobile base station, a portion thereof, and/or substantially any device that provides wireless network access. In addition, for example, wireless device 104 can be a UE, modem (or other tethered device), a portion thereof, and/or substantially any device that receives access to a wireless network, as described.

Access point 102 can comprise a channel initializing component 202 that implements one or more logical channels for communicating with wireless device 104 over a set of allocated resources, a resource scheduling component 204 that assigns resources to wireless device 104 for communicating over the one or more logical channels, a feedback receiving component 206 that obtains feedback related to communicating with wireless device 104 and/or other wireless devices, and an optimized PBR determining component 302 that can compute an optimized PBR for one or more logical channels based at least in part on the feedback. Access point 102 additionally comprises a PBR adjusting component 208 that can modify a PBR related to the one or more logical channels based on the feedback and a PBR communicating component 210 that provides the modified PBR to the wireless device 104.

According to an example, as described, wireless device 104 can establish connection with access point 102, and channel initializing component 202 can implement one or more logical channels for communicating with wireless device 104. Moreover, as described, channel initializing component 202 can associate a priority and PBR to the one or more logical channels, which can be based in part on a GBR (which can be specified by hardcoding, configuration, network specification, etc.), and can communicate the priority and PBR to wireless device 104. Wireless device 104 can utilize the one or more logical channels according to the priority and PBR. In addition, resource scheduling component 204 can allocate a set of resources to wireless device 104 based at least in part on the PBRs of the one or more logical channels (e.g., a set of resources that allows the PBRs to be achieved). Moreover, as described, feedback receiving component 206 can obtain one or more feedback parameters regarding communicating with other wireless devices, and channel initializing component 202 can select PBR for the one or more logical channels based at least in part on the one or more feedback parameters. In another example, PBR adjusting component 208 can similarly adjust PBRs (e.g., for access point 102, wireless device 104, and/or specific to wireless device 104 resource allocation, as described) based at least in part on the one or more feedback parameters.

In addition, for example, optimized PBR determining component 302 can compute one or more optimized PBRs for one or more logical channels based at least in part on maximizing utility of the one or more logical channels over substantially all wireless devices served by access point 102. For example, GBR requirements can be modeled using utility functions that have high slope at values less than the GBR and low slope at values more than the GBR. Optimized PBR determining component 302 can select a PBR for one or more logical channels based on the set of x_{ue,lc}'s which maximize the following sum of utilities:

$${\sum }_{ue} {\sum }_{lc} {U}_{ue , lc} ( {x}_{ue , lc} )$$

where U_{ue,lc} is the utility function for wireless device ue and logical channel lc, and x_{ue,lc} is the average rate at which the wireless device ue is served at logical channel lc, as received by feedback receiving component 206. The optimal solution to the above problem depends on the channel conditions on the link from access point 102 to wireless device 104 and the transmission power of wireless device 104. Once optimized PBR determining component 302 has computed optimized PBRs for substantially all logical channels according to the utility function, PBR adjusting component 208 can modify PBRs of the one or more logical channels according to the optimized PBRs. In addition, as described, PBR communicating component 210 can provide the adjusted PBRs to wireless device 104 (e.g., where adjusted over a threshold level).

Moreover, in one example, wireless device 104 utilizes PBRs and priorities to multiplex packets over resources allocated by access point 102. Thus, in one example as described, wireless device 104 may multiplex packets inconsistently with the resource allocation computed by access point 102 (e.g., where radio conditions change for wireless device 104 and it requires additional resources to communicate to access point 102). Thus, for example, feedback receiving component 206 can obtain feedback regarding average resource allocation to the wireless device 104 over a period of time (e.g., and/or a current resource allocation), and optimized PBR determining component 302 can configure optimized PBRs specific to wireless device 104 such that the sum of utilities of average rates across the logical channels for each wireless device is maximized for average resource allocation to wireless device 104.

It is to be appreciated, as described, that feedback receiving component 206, optimized PBR determining component 302, PBR adjusting component 208, and PBR communicating component 210 can all operate at an RRC layer. In this regard, PBR adjusting component 208 can communicate modified PBRs to resource scheduling component 204 for modifying a scheduling policy for the wireless devices based on the PBRs, a trend of the PBRs over a period of time, and/or the like. In another example, optimized PBR determining component 302, and PBR adjusting component 208 can be implemented within the resource scheduling component 204 or a related layer (e.g., MAC layer). In this example, PBRs can be optimized and/or adjusted according to feedback in the layer, and PBR adjusting component 208 can provide adjusted PBRs to the RRC layer for communicating to wireless device 104. Additionally, as mentioned above, the functionalities can be applied to groups of logical channels in addition or alternatively to single logical channels.

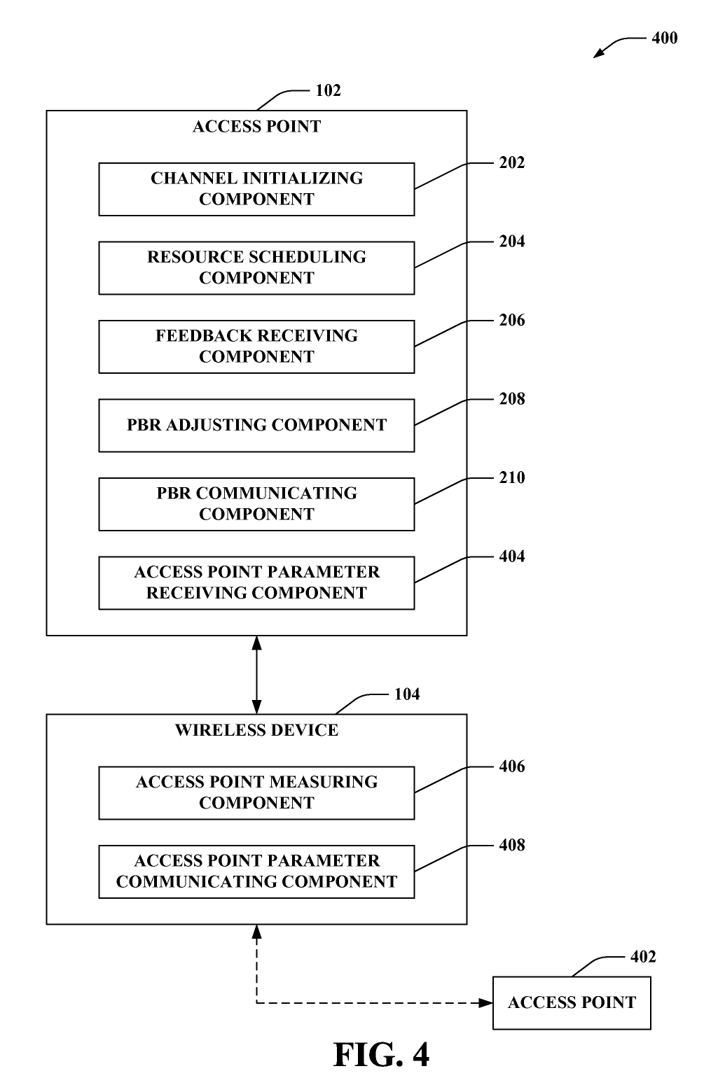

Referring now to FIG. 4, illustrated is a wireless communications system 400 that facilitates adjusting PBRs for one or more logical channels according to one or more parameters related to neighboring access points. System 400 includes access points 102 and 402 that provide one or more wireless devices, such as wireless device 104, with access to a wireless network (not shown). As described, access point 102 can communicate with wireless device 104 over one or more logical channels. Access points 102 and 402 can each be a macrocell access point, femtocell access point, picocell access point, mobile base station, a portion thereof, and/or substantially any device that provides wireless network access. In addition, for example, wireless device 104 can be a UE, modem (or other tethered device), a portion thereof, and/or substantially any device that receives access to a wireless network, as described.

Access point 102 can comprise a channel initializing component 202 that implements one or more logical channels for communicating with wireless device 104 over a set of allocated resources, a resource scheduling component 204 that assigns resources to wireless device 104 for communicating over the one or more logical channels, and a feedback receiving component 206 that obtains feedback related to communicating with wireless device 104 and/or other wireless devices. Access point 102 additionally comprises a PBR adjusting component 208 that can modify a PBR related to the one or more logical channels based on the feedback, a PBR communicating component 210 that provides the modified PBR to the wireless device 104, and an access point parameter receiving component 404 that can obtain one or more parameters regarding one or more neighboring access points. Wireless device 104 comprises an access point measuring component 406 that determines one or more parameters regarding one or more neighboring access points, and an access point parameter communicating component 408 that provides the one or more parameters to a disparate access point.

According to an example, as described, wireless device 104 can establish connection with access point 102, and channel initializing component 202 can implement one or more logical channels for communicating with wireless device 104. Moreover, as described, channel initializing component 202 can associate a priority and PBR to the one or more logical channels, which can be based in part on a GBR (which can be specified by hardcoding, configuration, network specification, etc.), and can communicate the priority and PBR to wireless device 104. Wireless device 104 can utilize the one or more logical channels according to the priority and PBR. In addition, resource scheduling component 204 can allocate a set of resources to wireless device 104 based at least in part on the PBRs of the one or more logical channels (e.g., a set of resources that allows the PBRs to be achieved). Moreover, as described, feedback receiving component 206 can obtain one or more feedback parameters regarding communicating with other wireless devices, and channel initializing component 202 can select PBR for the one or more logical channels based at least in part on the one or more feedback parameters. In another example, PBR adjusting component 208 can similarly adjust PBRs (e.g., for access point 102, wireless device 104, and/or specific to wireless device 104 resource allocation, as described) based at least in part on the one or more feedback parameters.

Moreover, for example, PBR adjusting component 208 can determine PBRs for the one or more logical channels based at least in part on channel gains to interfering access points. In this example, access point measuring component 406 can determine the channel gain to access point 402 (and/or additional access points) based at least in part on reference signals or other broadcast signs transmitted by the access point 402. This can be an independent measurement performed by wireless device 104 (e.g., based on a timer or event), a measurement performed as part of handover, a measurement requested by access point 102, and/or the like. Access point parameter communicating component 408 can transmit one or more parameters regarding the radio conditions (e.g., quality or signal-to-noise ratio of the reference signal) to access point 102. This can include information such as overload indication, high interference condition, and/or the like from an interference management mechanism on the uplink. In this example, access point parameter receiving component 404 can obtain the one or more parameters, and PBR adjusting component 208 can modify PBRs based further at least in part on the one or more parameters. Thus, in an example, PBR adjusting component 208 uses the estimate of a channel gain (or loss) to access point 402 for adjusting one or more PBRs. Moreover, for example, this estimate can be used in conjunction with information received regarding intercell interference management (e.g., overload indication, high interference condition, etc.) so that PBR adjusting component 208 can determine interference caused by wireless device 104 to access point 402 on the uplink and can accordingly adjust one or more PBRs to account for a limit on interference at access point 402.

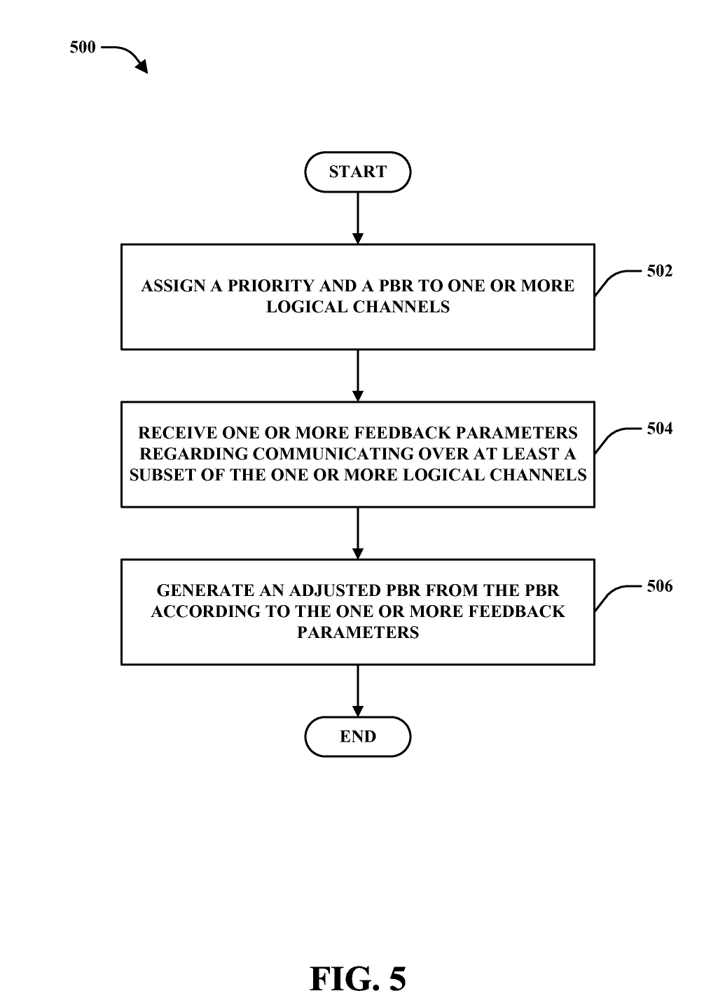

Referring now to FIGS. 5-8, methodologies that can be performed in accordance with various aspects set forth herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Turning now to FIG. 5, an example methodology 500 is shown that facilitates adjusting a PBR based at least in part on one or more feedback parameters. At 502, a priority and a PBR can be assigned to one or more logical channels. As described, the priority and PBR can be assigned upon initializing the one or more logical channels with one or more wireless devices. In addition, the PBR can be assigned based at least in part on a GBR and/or one or more feedback parameters from a scheduler or RLC layer, as described above. At 504, one or more feedback parameters regarding communicating over at least a subset of the one or more logical channels can be received. The one or more feedback parameters, for example, can be received from a MAC layer scheduler, an RLC layer, etc., and can relate to a resource allocation or resource allocation history of one or more wireless devices (e.g., over a period of time), a served rate of the one or more wireless devices, etc., as described previously. At 506, an adjusted PBR can be generated from the PBR according to the one or more feedback parameters. For example, the adjusted PBR can be provided to a scheduler for modifying a scheduling policy, a wireless device for utilization in communicating over one or more logical channels, and/or the like.

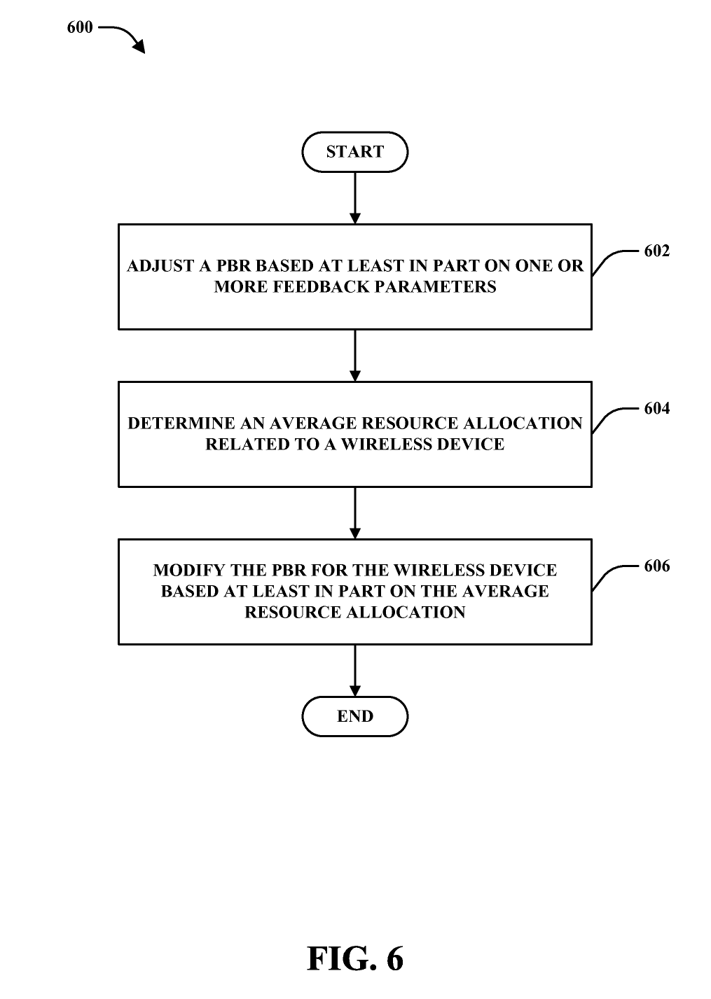

Referring to FIG. 6, an example methodology 600 that modifies a PBR specific to a wireless device is illustrated. At 602, a PBR can be adjusted based at least in part on one or more feedback parameters. Thus, as described above, the feedback parameters can be received in relation to communicating with one or more wireless devices, and a PBR for one or more logical channels can be adjusted according to the feedback parameters. In one example, however, where a wireless device experiences degradation in signal quality or otherwise is not able to communicate over assigned resources, PBRs related to the specific wireless device can be adjusted. Thus, for example, at 604, an average resource allocation related to the wireless device can be determined, and at 606, the PBR for the wireless device can be modified based at least in part on the average resource allocation. In this regard, for example, the PBR can be proportioned according to the resource allocation to increase likelihood that data can be transmitted over substantially all logical channels, or at least a specified set of all the logical channels.

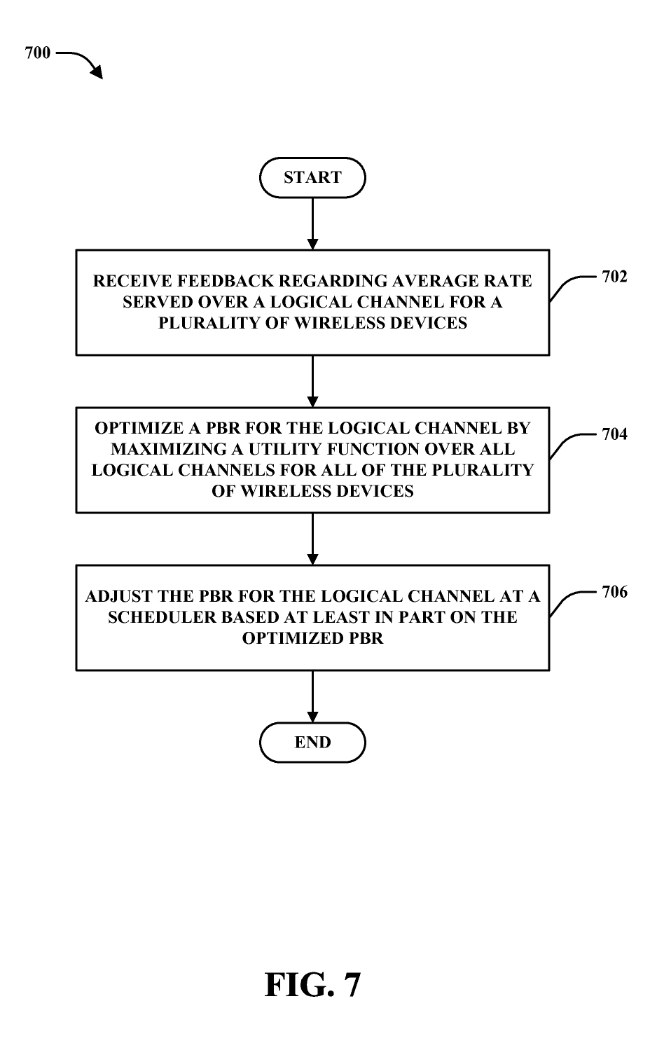

Turning now to FIG. 7, an example methodology 700 is shown that facilitates determining optimized PBRs according to a utility function. At 702, feedback regarding average rate served over a logical channel can be received for a plurality of wireless devices. As described, the feedback can be received from a MAC layer scheduler, an RLC layer, etc. At 704, a PBR for the logical channel can be optimized by maximizing a utility function over all logical channels for all of the plurality of wireless devices, as described. At 706, the PBR can be adjusted for the logical channel at a scheduler based at least in part on the optimized PBR. The scheduler can accordingly utilize the adjusted PBR in scheduling resources to one or more wireless devices.

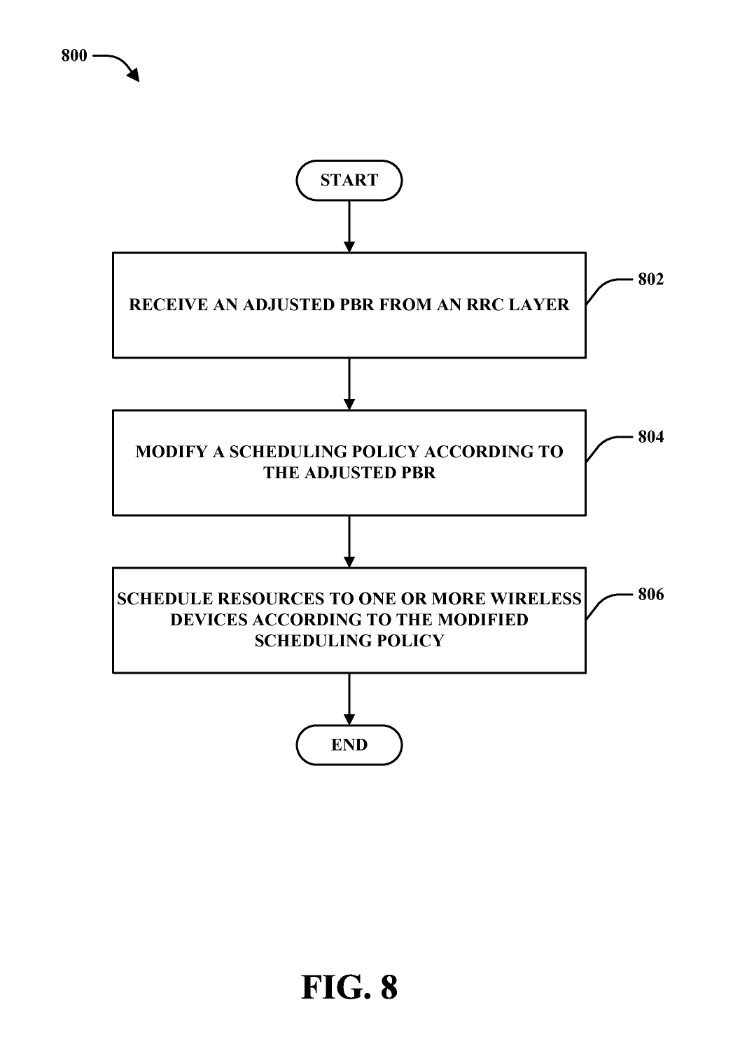

Referring to FIG. 8, an example methodology 800 that facilitates scheduling resources based on an adjusted PBR is illustrated. At 802, an adjusted PBR can be received from an RRC layer. As described, the PBR can be adjusted based at least in part on feedback related to communicating with a plurality of wireless devices. At 804, a scheduling policy can be modified according to the adjusted PBR. For example, this can include defining resource scheduling according to the adjusted PBR (e.g., if a PBR is adjusted upward, additional resources can be assigned according to the scheduling policy, and/or vice versa). At 806, resources can be scheduled to one or more devices according to the modified scheduling policy.

It will be appreciated that, in accordance with one or more aspects described herein, inferences can be made regarding determining a value by which to adjust a PBR, maximizing utility of one or more PBRs, as described, and/or the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

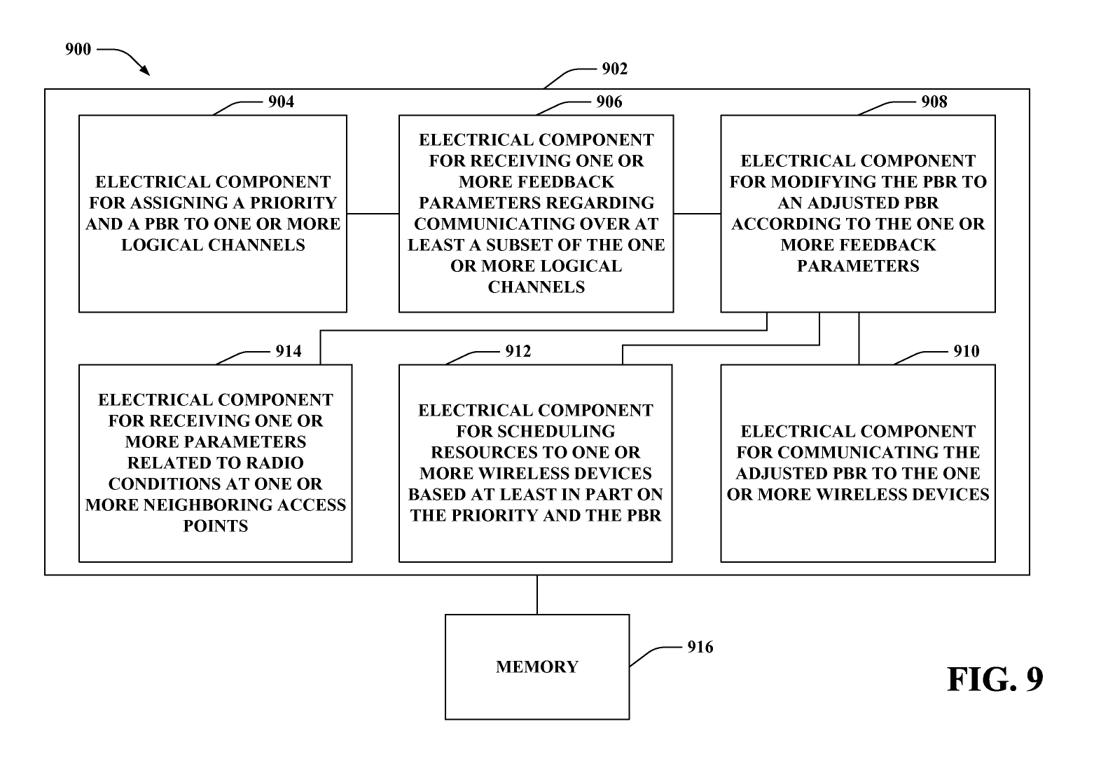

With reference to FIG. 9, illustrated is a system 900 that facilitates adjusting PBRs for one or more logical channels according to scheduler or RLC layer feedback. For example, system 900 can reside at least partially within a base station, mobile device, or another device that provides access to a wireless network. It is to be appreciated that system 900 is represented as including functional blocks, which can be functional blocks that represent functions implemented by a processor, software, or combination thereof (e.g., firmware). System 900 includes a logical grouping 902 of electrical components that can act in conjunction. For instance, logical grouping 902 can include an electrical component for assigning a priority and a PBR to one or more logical channels 904. As described, the priority and PBR can be assigned upon initializing the one or more logical channels with a wireless device. Further, logical grouping 902 can comprise an electrical component for receiving one or more feedback parameters regarding communicating over at least a subset of the one or more logical channels 906.

As described, the one or more feedback parameters can be received from a MAC layer scheduler, an RLC layer, etc., and can relate to a resource allocation or resource allocation history of one or more wireless devices (e.g., over a period of time), a served rate of the one or more wireless devices, etc., as described. Moreover, logical grouping 902 can include an electrical component for modifying the PBR to an adjusted PBR according to the one or more feedback parameters 908. As described, for example, the feedback parameters can indicate a rate of communication with one or more wireless devices (e.g., an average over the wireless devices), resource allocations, etc., and a modification in PBR can be adjusted with the rate, resource allocations, etc. change to increase likelihood that data can be transmitted over substantially all logical channels. Further, logical grouping 902 includes an electrical component for communicating the adjusted PBR to the one or more wireless devices 910. In this regard, the one or more wireless devices can communicate over the one or more logical channels using the priority and adjusted PBR, as described. Moreover, logical grouping 902 can include an electrical component for scheduling resources to one or more wireless devices based at least in part on the priority and the PBR 912. In addition, electrical component 912 can reschedule resources based at least in part on an adjusted PBR.

Furthermore, logical grouping 902 can include an electrical component for receiving one or more parameters related to radio conditions at one or more neighboring access points 914. For example, electrical component 908 can modify the PBR based further at least in part on the one or more parameters, as described. Additionally, system 900 can include a memory 916 that retains instructions for executing functions associated with electrical components 904, 906, 908, 910, 912, and 914. While shown as being external to memory 916, it is to be understood that one or more of electrical components 904, 906, 908, 910, 912, and 914 can exist within memory 916.

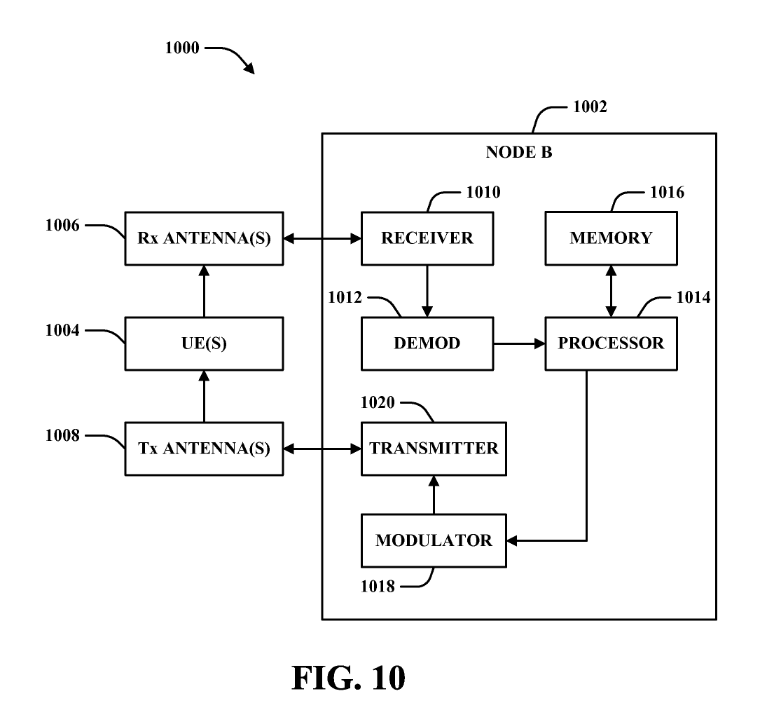

FIG. 10 is a block diagram of a system 1000 that can be utilized to implement various aspects of the functionality described herein. In one example, system 1000 includes a base station or Node B 1002. As illustrated, Node B 1002 can receive signal(s) from one or more UEs 1004 via one or more receive (Rx) antennas 1006 and transmit to the one or more UEs 1004 via one or more transmit (Tx) antennas 1008. Additionally, Node B 1002 can comprise a receiver 1010 that receives information from receive antenna(s) 1006. In one example, the receiver 1010 can be operatively associated with a demodulator (Demod) 1012 that demodulates received information. Demodulated symbols can then be analyzed by a processor 1014. Processor 1014 can be coupled to memory 1016, which can store information related to code clusters, access terminal assignments, lookup tables related thereto, unique scrambling sequences, and/or other suitable types of information. In one example, Node B 1002 can employ processor 1014 to perform methodologies 500, 600, 700, 800, and/or other similar and appropriate methodologies. Node B 1002 can also include a modulator 1018 that can multiplex a signal for transmission by a transmitter 1020 through transmit antenna(s) 1008.

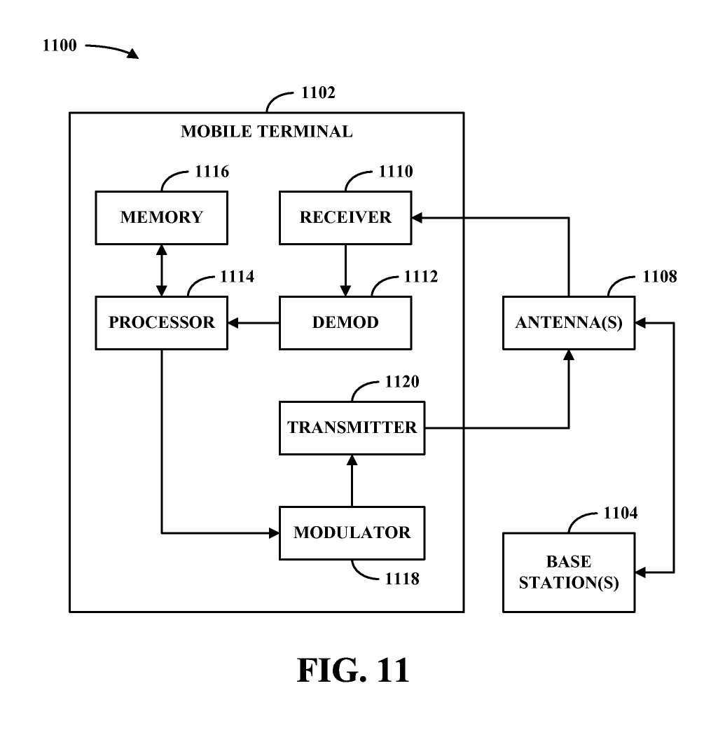

FIG. 11 is a block diagram of another system 1100 that can be utilized to implement various aspects of the functionality described herein. In one example, system 1100 includes a mobile terminal 1102. As illustrated, mobile terminal 1102 can receive signal(s) from one or more base stations 1104 and transmit to the one or more base stations 1104 via one or more antennas 1108. Additionally, mobile terminal 1102 can comprise a receiver 1110 that receives information from antenna(s) 1108. In one example, receiver 1110 can be operatively associated with a demodulator (Demod) 1112 that demodulates received information. Demodulated symbols can then be analyzed by a processor 1114. Processor 1114 can be coupled to memory 1116, which can store data and/or program codes related to mobile terminal 1102. Additionally, mobile terminal 1102 can employ processor 1114 to perform methodologies 500, 600, 700, 800, and/or other similar and appropriate methodologies. Mobile terminal 1102 can also employ one or more components described in previous figures to effectuate the described functionality; in one example, the components can be implemented by the processor 1114. Mobile terminal 1102 can also include a modulator 1118 that can multiplex a signal for transmission by a transmitter 1120 through antenna(s) 1108.

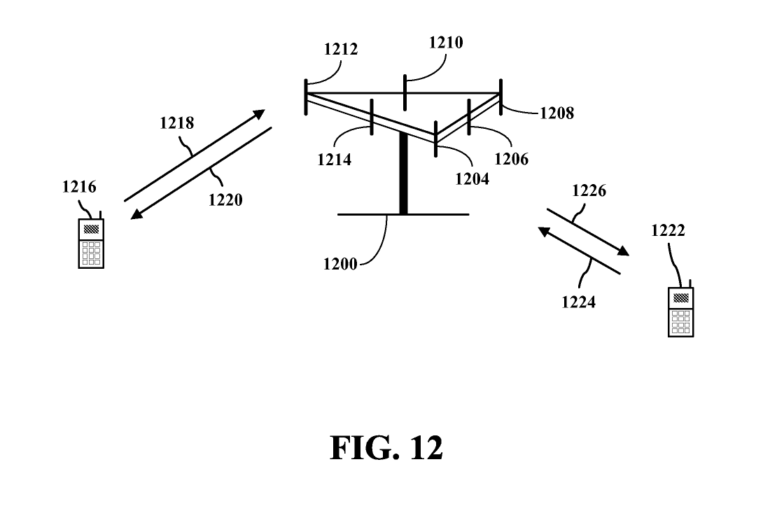

Referring now to FIG. 12, an illustration of a wireless multiple-access communication system is provided in accordance with various aspects. In one example, an access point 1200 (AP) includes multiple antenna groups. As illustrated in FIG. 12, one antenna group can include antennas 1204 and 1206, another can include antennas 1208 and 1210, and another can include antennas 1212 and 1214. While only two antennas are shown in FIG. 12 for each antenna group, it should be appreciated that more or fewer antennas may be utilized for each antenna group. In another example, an access terminal 1216 can be in communication with antennas 1212 and 1214, where antennas 1212 and 1214 transmit information to access terminal 1216 over forward link 1220 and receive information from access terminal 1216 over reverse link 1218. Additionally and/or alternatively, access terminal 1222 can be in communication with antennas 1206 and 1208, where antennas 1206 and 1208 transmit information to access terminal 1222 over forward link 1226 and receive information from access terminal 1222 over reverse link 1224. In a frequency division duplex system, communication links 1218, 1220, 1224 and 1226 can use different frequency for communication. For example, forward link 1220 may use a different frequency then that used by reverse link 1218.

Each group of antennas and/or the area in which they are designed to communicate can be referred to as a sector of the access point. In accordance with one aspect, antenna groups can be designed to communicate to access terminals in a sector of areas covered by access point 1200. In communication over forward links 1220 and 1226, the transmitting antennas of access point 1200 can utilize beamforming in order to improve the signal-to-noise ratio of forward links for the different access terminals 1216 and 1222. Also, an access point using beamforming to transmit to access terminals scattered randomly through its coverage causes less interference to access terminals in neighboring cells than an access point transmitting through a single antenna to all its access terminals.

An access point, e.g., access point 1200, can be a fixed station used for communicating with terminals and can also be referred to as a base station, a Node B, an access network, and/or other suitable terminology. In addition, an access terminal, e.g., an access terminal 1216 or 1222, can also be referred to as a mobile terminal, user equipment, a wireless communication device, a terminal, a wireless terminal, and/or other appropriate terminology.

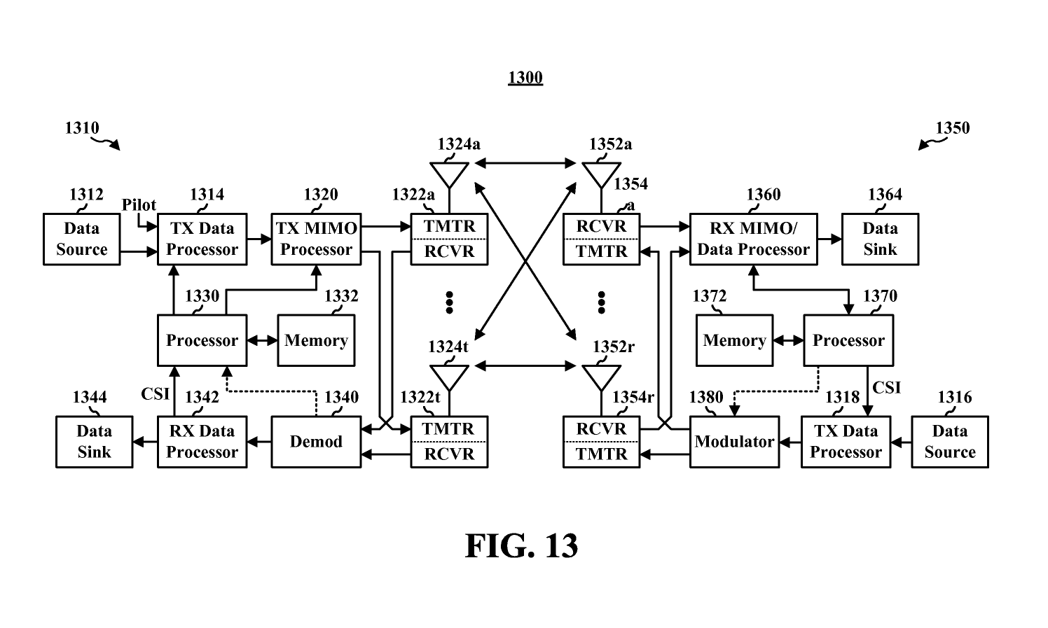

Referring now to FIG. 13, a block diagram illustrating an example wireless communication system 1300 in which various aspects described herein can function is provided. In one example, system 1300 is a multiple-input multiple-output (MIMO) system that includes a transmitter system 1310 and a receiver system 1350. It should be appreciated, however, that transmitter system 1310 and/or receiver system 1350 could also be applied to a multi-input single-output system wherein, for example, multiple transmit antennas (e.g., on a base station), can transmit one or more symbol streams to a single antenna device (e.g., a mobile station). Additionally, it should be appreciated that aspects of transmitter system 1310 and/or receiver system 1350 described herein could be utilized in connection with a single output to single input antenna system.

In accordance with one aspect, traffic data for a number of data streams are provided at transmitter system 1310 from a data source 1312 to a transmit (TX) data processor 1314. In one example, each data stream can then be transmitted via a respective transmit antenna 1324. Additionally, TX data processor 1314 can format, encode, and interleave traffic data for each data stream based on a particular coding scheme selected for each respective data stream in order to provide coded data. In one example, the coded data for each data stream can then be multiplexed with pilot data using OFDM techniques. The pilot data can be, for example, a known data pattern that is processed in a known manner. Further, the pilot data can be used at receiver system 1350 to estimate channel response. Back at transmitter system 1310, the multiplexed pilot and coded data for each data stream can be modulated (i.e., symbol mapped) based on a particular modulation scheme (e.g., BPSK, QSPK, M-PSK, or M-QAM) selected for each respective data stream in order to provide modulation symbols. In one example, data rate, coding, and modulation for each data stream can be determined by instructions performed on and/or provided by processor 1330.

Next, modulation symbols for all data streams can be provided to a TX MIMO processor 1320, which can further process the modulation symbols (e.g., for OFDM). TX MIMO processor 1320 can then provides N_{T} modulation symbol streams to N_{T} transceivers 1322a through 1322t. In one example, each transceiver 1322 can receive and process a respective symbol stream to provide one or more analog signals. Each transceiver 1322 can then further condition (e.g., amplify, filter, and up-convert) the analog signals to provide a modulated signal suitable for transmission over a MIMO channel. Accordingly, N_{T} modulated signals from transceivers 1322a through 1322t can then be transmitted from N_{T} antennas 1324a through 1324t, respectively.

In accordance with another aspect, the transmitted modulated signals can be received at receiver system 1350 by N_{R} antennas 1352a through 1352r. The received signal from each antenna 1352 can then be provided to respective transceivers 1354. In one example, each transceiver 1354 can condition (e.g., filter, amplify, and down-convert) a respective received signal, digitize the conditioned signal to provide samples, and then processes the samples to provide a corresponding “received” symbol stream. An RX MIMO/data processor 1360 can then receive and process the N_{R} received symbol streams from N_{R} transceivers 1354 based on a particular receiver processing technique to provide N_{T} “detected” symbol streams. In one example, each detected symbol stream can include symbols that are estimates of the modulation symbols transmitted for the corresponding data stream. RX MIMO/data processor 1360 can then process each symbol stream at least in part by demodulating, deinterleaving, and decoding each detected symbol stream to recover traffic data for a corresponding data stream. Thus, the processing by RX MIMO/data processor 1360 can be complementary to that performed by TX MIMO processor 1320 and TX data processor 1318 at transmitter system 1310. RX MIMO/data processor 1360 can additionally provide processed symbol streams to a data sink 1364.

In accordance with one aspect, the channel response estimate generated by RX MIMO/data processor 1360 can be used to perform space/time processing at the receiver, adjust power levels, change modulation rates or schemes, and/or other appropriate actions. Additionally, RX MIMO/data processor 1360 can further estimate channel characteristics such as, for example, signal-to-noise-and-interference ratios (SNRs) of the detected symbol streams. RX MIMO/data processor 1360 can then provide estimated channel characteristics to a processor 1370. In one example, RX MIMO/data processor 1360 and/or processor 1370 can further derive an estimate of the “operating” SNR for the system. Processor 1370 can then provide channel state information (CSI), which can comprise information regarding the communication link and/or the received data stream. This information can include, for example, the operating SNR. The CSI can then be processed by a TX data processor 1318, modulated by a modulator 1380, conditioned by transceivers 1354a through 1354r, and transmitted back to transmitter system 1310. In addition, a data source 1316 at receiver system 1350 can provide additional data to be processed by TX data processor 1318.

Back at transmitter system 1310, the modulated signals from receiver system 1350 can then be received by antennas 1324, conditioned by transceivers 1322, demodulated by a demodulator 1340, and processed by a RX data processor 1342 to recover the CSI reported by receiver system 1350. In one example, the reported CSI can then be provided to processor 1330 and used to determine data rates as well as coding and modulation schemes to be used for one or more data streams. The determined coding and modulation schemes can then be provided to transceivers 1322 for quantization and/or use in later transmissions to receiver system 1350. Additionally and/or alternatively, the reported CSI can be used by processor 1330 to generate various controls for TX data processor 1314 and TX MIMO processor 1320. In another example, CSI and/or other information processed by RX data processor 1342 can be provided to a data sink 1344.

In one example, processor 1330 at transmitter system 1310 and processor 1370 at receiver system 1350 direct operation at their respective systems. Additionally, memory 1332 at transmitter system 1310 and memory 1372 at receiver system 1350 can provide storage for program codes and data used by processors 1330 and 1370, respectively. Further, at receiver system 1350, various processing techniques can be used to process the N_{R} received signals to detect the N_{T} transmitted symbol streams. These receiver processing techniques can include spatial and space-time receiver processing techniques, which can also be referred to as equalization techniques, and/or “successive nulling/equalization and interference cancellation” receiver processing techniques, which can also be referred to as “successive interference cancellation” or “successive cancellation” receiver processing techniques.

It is to be understood that the aspects described herein can be implemented by hardware, software, firmware, middleware, microcode, or any combination thereof. When the systems and/or methods are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method, comprising:
assigning a priority and a prioritized bit rate (PBR) to one or more logical channels;
receiving one or more feedback parameters regarding communicating over at least a subset of the one or more logical channels; and
generating an adjusted PBR from the PBR according to the one or more feedback parameters.

2. The method of claim 1, further comprising providing the adjusted PBR to one or more wireless devices.

3. The method of claim 2, further comprising determining a variance between the PBR and the adjusted PBR is over a threshold variance, wherein the providing the adjusted PBR to the one or more wireless devices is based at least in part on the determining the variance is over the threshold variance.

4. The method of claim 1, wherein the receiving the one or more feedback parameters includes receiving the one or more feedback parameters related to communicating with one or more wireless devices from a scheduler at a media access control layer or from a radio link control layer.

5. The method of claim 4, wherein the receiving the one or more feedback parameters includes receiving a resource allocation history related to the one or more wireless devices, an average rate at which the one or more wireless devices are served, a rate at which the one or more wireless devices are served over at least one of the one or more logical channels, statistics regarding inter-services times of the one or more wireless devices, or an average carrier-to-interference ratio at the one or more wireless devices.

6. The method of claim 4, wherein the adjusting the PBR includes adjusting the PBR at a radio resource control layer.

7. The method of claim 4, further comprising providing the adjusted PBR to the scheduler.

8. The method of claim 7, further comprising modifying a scheduling policy at the scheduler related to the one or more wireless devices based at least in part on the adjusted PBR.

9. The method of claim 1, wherein the adjusting the PBR includes adjusting the PBR at a scheduler in a media access control layer.

10. The method of claim 9, further comprising providing the PBR to a radio resource control layer for communicating to one or more wireless devices.

11. The method of claim 1, further comprising receiving one or more parameters related to radio conditions at one or more neighboring access points, wherein the generating the adjusted PBR from the PBR is further based at least in part on determining a channel gain to the one or more neighboring access points based at least in part on the one or more parameters related to radio conditions.

12. The method of claim 11, wherein the one or more parameters related to radio conditions include an overload indication or high interference condition corresponding to the one or more neighboring access points.

13. The method of claim 1, further comprising computing a plurality of optimized PBRs related to the one or more logical channels based at least in part on a utility function related to the one or more logical channels over one or more wireless devices, wherein the generating the adjusted PBR is further based at least in part on at least one of the plurality of optimized PBRs.

14. A wireless communications apparatus, comprising:
at least one processor configured to:
define a priority and a prioritized bit rate (PBR) for one or more logical channels;
obtain one or more feedback parameters related to communicating with one or more wireless devices over at least a subset of the one or more logical channels; and
modify the PBR to an adjusted PBR according to the one or more feedback parameters; and
a memory coupled to the at least one processor.

15. The wireless communications apparatus of claim 14, wherein the at least one processor is further configured to signal the adjusted PBR to the one or more wireless devices.

16. The wireless communications apparatus of claim 14, wherein the at least one processor obtains the one or more feedback parameters from a scheduler at a media access control layer or a radio link control layer.

17. The wireless communications apparatus of claim 16, wherein the at least one processor is further configured to communicate the adjusted PBR to the scheduler.

18. The wireless communications apparatus of claim 17, wherein the scheduler modifies a scheduling policy related to the one or more wireless devices based at least in part on the adjusted PBR.

19. The wireless communications apparatus of claim 14, wherein the at least one processor modifies the PBR to the adjusted PBR at a scheduler in a media access control layer.

20. The wireless communications apparatus of claim 19, wherein the scheduler provides the adjusted PBR to a radio resource control layer.

21. The wireless communications apparatus of claim 14, wherein the at least one processor is further configured to receive one or more parameters regarding one or more neighboring access points, and modifies the PBR to the adjusted PBR based at least in part on one or more parameters.

22. An apparatus, comprising:
means for assigning a priority and a prioritized bit rate (PBR) to one or more logical channels;
means for receiving one or more feedback parameters regarding communicating over at least a subset of the one or more logical channels; and
means for modifying the PBR to an adjusted PBR according to the one or more feedback parameters.

23. The apparatus of claim 22, further comprising means for communicating the adjusted PBR to one or more wireless devices.

24. The apparatus of claim 22, further comprising means for scheduling resources to one or more wireless devices based at least in part on the priority and the PBR, wherein the means for receiving receives the one or more feedback parameters related to communicating with the one or more wireless devices from the means for scheduling resources.

25. The apparatus of claim 24, wherein the means for modifying the PBR provides the adjusted PBR to the means for scheduling resources.

26. The apparatus of claim 25, wherein the means for scheduling resources modifies a scheduling policy related to the one or more wireless devices based at least in part on the adjusted PBR.

27. The apparatus of claim 22, further comprising means for receiving one or more parameters related to radio conditions at one or more neighboring access points, wherein the means for modifying further modifies the PBR based at least in part on the one or more parameters.

28. A computer program product, comprising:
a computer-readable medium comprising:
code for causing at least one computer to define a priority and a prioritized bit rate (PBR) for one or more logical channels;
code for causing the at least one computer to obtain one or more feedback parameters related to communicating with one or more wireless devices over at least a subset of the one or more logical channels; and
code for causing the at least one computer to modify the PBR to an adjusted PBR according to the one or more feedback parameters.

29. The computer program product of claim 28, wherein the computer-readable medium further comprises code for causing the at least one computer to signal the adjusted PBR to the one or more wireless devices.

30. The computer program product of claim 28, wherein the code for causing the at least one computer to obtain obtains the one or more feedback parameters from a scheduler at a media access control layer or a radio link control layer.

31. The computer program product of claim 30, wherein the computer-readable medium further comprises code for causing the at least one computer to communicate the adjusted PBR to the scheduler.

32. The computer program product of claim 31, wherein the scheduler modifies a scheduling policy related to the one or more wireless devices based at least in part on the adjusted PBR.

33. The computer program product of claim 28, wherein the code for causing the at least one computer to modify modifies the PBR to the adjusted PBR at a scheduler in a media access control layer.

34. The computer program product of claim 33, wherein the computer-readable medium further comprises code for causing the at least one computer to communicate the adjusted PBR to a radio resource control layer.

35. The computer program product of claim 29, wherein the computer-readable medium further comprises code for causing the at least one computer to receive one or more parameters regarding one or more neighboring access points, and the code for causing the at least one computer to modify modifies the PBR to the adjusted PBR based at least in part on one or more parameters.

36. An apparatus, comprising:
a channel initializing component that assigns a priority and a prioritized bit rate (PBR) to one or more logical channels;
a feedback receiving component that obtains one or more feedback parameters regarding communicating over at least a subset of the one or more logical channels; and
a PBR adjusting component that modifies the PBR to an adjusted PBR according to the one or more feedback parameters.

37. The apparatus of claim 36, further comprising a PBR communicating component that provides the adjusted PBR to one or more wireless devices.

38. The apparatus of claim 36, further comprising a resource scheduling component that allocates resources to one or more wireless devices based at least in part on the priority and the PBR, wherein the feedback receiving component obtains the one or more feedback parameters related to communicating with the one or more wireless devices from a the resource scheduling component.

39. The apparatus of claim 38, wherein the PBR adjusting component provides the adjusted PBR to the resource scheduling component.

40. The apparatus of claim 39, wherein the resource scheduling component modifies a scheduling policy related to the one or more wireless devices based at least in part on the adjusted PBR.

41. The apparatus of claim 36, further comprising an access point parameter receiving component that obtains one or more parameters related to radio conditions at one or more neighboring access points, wherein the PBR adjusting component further modifies the PBR based at least in part on the one or more parameters.
